(19) United States
(12) Patent Application Publication
(10) Pub. No.: US 2018/0183272 A1
(43) Pub. Date: Jun. 28, 2018

(54) NON-CONTACT POWER FEEDING DEVICE AND CONTROL METHOD FOR THE SAME

(71) Applicant: OMRON Corporation, Kyoto-shi (JP)

(72) Inventor: Goro NAKAO, Inazawa-shi (JP)

(73) Assignee: OMRON Corporation, Kyoto-shi (JP)

(21) Appl. No.: 15/897,198

(22) Filed: Feb. 15, 2018

Related U.S. Application Data
(63) Continuation of application No. PCT/JP2016/085942, filed on Dec. 2, 2016.

(30) Foreign Application Priority Data
Dec. 18, 2015 (JP) 2015-247242

(51) Int. Cl. H02J 50/12

(52) U.S. Cl. CPC H02J 50/12

(57) ABSTRACT

A non-contact power feeding device includes a power transmission device and a power reception device having a receiving coil to which power is transmitted in a non-contact manner from the power transmission device. The power transmission device has a resonant circuit and a power supply circuit. The resonant circuit has a transmitting coil to perform power transmission with the receiving coil. The power supply circuit supplies AC power having an adjustable operating frequency to the resonant circuit. The power transmission device has a voltage detection circuit to detect an AC voltage applied to the transmitting coil and a control circuit to adjust the operating frequency of the AC power. The control circuit changes the operating frequency in a lower direction from an initial frequency located in an inductance range, and, when it is determined that the AC voltage has reached a prescribed value, ends processing for changing the operating frequency.

### CROSS REFERENCE TO RELATED APPLICATIONS

This application is a continuation application of International Application No. PCT/JP2016/085942, filed on Dec. 2, 2016, which claims priority based on the Article 8 of Patent Cooperation Treaty from prior Japanese Patent Application No. 2015-247242, filed on Dec. 18, 2015, the entire contents of which are incorporated herein by reference.

### TECHNICAL FIELD

The disclosure relates to a non-contact power feeding device and a control method for the same.

### RELATED ART

Heretofore, so-called non-contact power feeding (also called wireless power feeding) technologies for transmitting power through space without the intermediary of metal contacts or the like have been studied.

As one non-contact power feeding technology, a magnetic field resonance (also called magnetic field resonant coupling or magnetic resonance) method is known (see Patent Document 1). With the magnetic field resonance method, resonant circuits that include a coil are respectively provided on a power transmission side and a power reception side, and a coupled magnetic field state in which energy transfer by magnetic field resonance is possible between the coil on the power transmission side and the coil on the power reception side is produced, by tuning the resonant frequencies of these resonant circuits. Power is thereby transmitted through space from the coil on the power transmission side to the coil on the power reception side. With non-contact power feeding by the magnetic field resonance method, it is possible to attain an energy transfer efficiency of around several tens of percent, and it is possible to comparatively increase the distance between the coil on the power transmission side and the coil on the power reception side. For example, in the case where each coil has a size of around several tens of centimeters, the distance between the coil on the power transmission side and the coil on the power reception side can be set from several tens of centimeters to one meter or more.

On the other hand, with the magnetic field resonance method, it is known that the energy transfer power amount decreases when the distance between the coil on the power transmission side and the coil on the power reception side approaches closer than an optimal distance (see Patent Document 2). This is due to the degree of coupling between the two coils changing according to the distance between the two coils, and the resonant frequency between the two coils changing. In the case where the distance between the two coils is appropriate, there is one resonant frequency between the two coils, and that resonant frequency is equal to the resonant frequency of the resonant circuits on the power transmission side and the power reception side, which is determined by the inductance of the coils and the electrostatic capacity of the capacitors. However, when the distance between the two coils shortens and the degree of coupling increases, two resonant frequencies appear between the two coils. One will be a higher frequency than the resonant frequency of the resonant circuits themselves, and the other will be a lower frequency than the resonant frequency of the resonant circuits themselves. The resonant frequency between the two coils thus no longer coincides with the resonant frequency of the resonant circuits themselves when the degree of coupling increases, and thus the energy transfer power amount decreases, since the resonance between the coils does not occur satisfactorily, even when alternating current (AC) power having the resonant frequency of the resonant circuits is supplied to the resonant circuit on the power transmission side.

In view of this, the power transmission device disclosed in Patent Document 2 has a power transmission coil that transmits, as magnetic field energy, power supplied from a power source unit to a power reception resonant coil that resonates at a resonant frequency that produces magnetic field resonance and whose resonant point differs from the power reception resonant coil. This power transmission device thereby enables transmission and reception of power between the power transmission coil and the power reception resonant coil, without utilizing magnetic field resonance.

Also, Non-patent Document 1 describes realizing soft switching by operating a power transmission device at a higher operating frequency than the resonant frequency. The frequency domain in which the resonant frequency is also high is also referred to as a ZVS (Zero Voltage Switching) mode or an inductance range.

### RELATED ART DOCUMENTS

### Patent Documents

Patent Document 1: JP 2009-501510T

Patent Document 2: WO 2011/064879

### Non-patent Documents

Non-patent Document 1: Yoshihiro TOMIHISA, et al., “Research on LLC Resonant Converter”, Origin Technical Journal, October 2013 (no. 76).

### SUMMARY OF THE INVENTION

### Problems to be Solved by the Invention

With the magnetic field resonance method, improvement in the energy transfer power amount is attained, by configuring the resonant frequencies between the coil on the power transmission side and the coil on the power reception side to be the same. However, with the technology disclosed in Patent Document 2, since the resonant point of the power transmission coil differs from the resonant point of the power reception resonant coil and a soft switching operation is not realized, there is a risk that the energy transfer power amount will decrease.

In view of this, one or more embodiments may provide a non-contact power feeding device that is able to suppress any decrease in the energy transfer power amount, even when the distance between the coil on the power transmission side and the coil on the power reception side changes.

### Means for Solving the Problems

As one aspect, a non-contact power feeding device including a power transmission device and a power reception device having a receiving resonant circuit including a receiving coil to which power is transmitted in a non-contact manner from the power transmission device is provided. In this non-contact power feeding device, the power transmission device includes a transmitting resonant circuit and a power supply circuit. The transmitting resonant circuit has a capacitor and a transmitting coil connected to one end of the capacitor and configured to perform power transmission with the receiving coil. Also, the power supply circuit is configured to supply AC power having an adjustable operating frequency to the transmitting resonant circuit. Furthermore, the power transmission device has a voltage detection circuit configured to detect an AC voltage applied to the transmitting coil and a control circuit configured to adjust the operating frequency of the AC power supplied from the power supply circuit. The control circuit has a storage unit configured to store an initial frequency higher than any of resonant frequencies at which an impedance of a power transmission circuit including the transmitting resonant circuit and the receiving resonant circuit takes a local minimum value, an initial frequency setting unit, an operating frequency changing unit, and an AC voltage determination unit. The initial frequency setting unit is configured to set the operating frequency to the initial frequency when starting non-contact power feeding to the power reception device. The operating frequency changing unit is configured to change the operating frequency in a lower direction, and the AC voltage determination unit is configured to determine whether the AC voltage has reached a prescribed value. The operating frequency changing unit ends processing for changing the operating frequency, when it is determined that the AC voltage has reached the prescribed value.

In this non-contact power feeding device, it may be preferable that the control circuit of the power transmission device further has an operating frequency correction unit configured to further change the operating frequency to be lower, when a predetermined time period has elapsed after it is determined that the AC voltage has reached the prescribed value, a change voltage determination unit configured to determine whether the AC voltage after the change is higher than the AC voltage before the change, and an operating frequency re-setting unit configured to move the operating frequency to a change frequency that is higher than any of the resonant frequencies and less than or equal to the initial frequency, when it is determined that the AC voltage after the change is higher than the AC voltage before the change.

In this case, it may be preferable that the change frequency is the initial frequency.

Also, in this case, it may be preferable that the storage unit further stores a change frequency table showing a relationship between the AC voltage and the change frequency, and the operating frequency re-setting unit changes the operating frequency to the change frequency, with reference to the change frequency table.

As another mode, a control method for a non-contact power feeding device including a power transmission device and a power reception device having a receiving resonant circuit including a receiving coil to which power is transmitted in a non-contact manner from the power transmission device. In this non-contact power feeding device, the power transmission device has a transmitting resonant circuit and a power supply circuit. The transmitting resonant circuit has a capacitor and a transmitting coil connected to one end of the capacitor and configured to perform power transmission with the receiving coil. Also, the power supply circuit is configured to supply AC power having an adjustable operating frequency to the transmitting resonant circuit. Furthermore, the power transmission device has a voltage detection circuit configured to detect an AC voltage applied to the transmitting coil, and a control circuit configured to adjust the operating frequency of the AC power supplied from the power supply circuit. The control method for the non-contact power feeding device includes setting an initial frequency higher than both of a first resonant frequency and a second resonant frequency at which an impedance of a power transmission circuit including the transmitting resonant circuit and the receiving resonant circuit takes a local minimum value as the operating frequency, when starting non-contact power feeding to the power reception device, changing the operating frequency in a lower direction, determining whether the AC voltage has reached a prescribed value, and ending processing for changing the operating frequency, when it is determined that the AC voltage has reached the prescribed value.

### Effects of the Invention

A non-contact power feeding device according to one or more embodiments may achieve the effect of being able to suppress any decrease in the energy transfer power amount, even when the distance between the coil on the power transmission side and the coil on the power reception side changes.

### BRIEF DESCRIPTION OF THE DRAWINGS

FIG. 1 is a schematic configuration diagram illustrating a non-contact power feeding device according to one or more embodiments.

FIG. 2 is an equivalent circuit diagram illustrating a non-contact power feeding device.

FIG. 3 is a diagram illustrating an example of the frequency characteristics of impedance of an equivalent circuit, such as in FIG. 2.

FIG. 4 is an internal block diagram illustrating a control circuit shown in FIG. 2.

FIG. 5 is a flowchart illustrating power transmission processing by a computational circuit shown in FIG. 4.

FIG. 6 is a detailed flowchart illustrating power transmission start processing shown in FIG. 5.

FIG. 7 is a diagram illustrating an example of the frequency characteristics of impedance in power transmission start processing, such as in FIG. 6.

FIG. 8 is a detailed flowchart illustrating operating frequency correction processing, such as in FIG. 5.

FIG. 9 is a diagram illustrating an example of the frequency characteristics of impedance in operating frequency correction processing, such as in FIG. 8.

FIG. 10 is a diagram illustrating another example of the frequency characteristics of impedance in operating frequency correction processing, such as in FIG. 8.

FIG. 11A is an internal block diagram illustrating a control circuit according to another embodiment.

FIG. 11B is a diagram illustrating a change frequency table shown in FIG. 11A.

FIG. 12 is a flowchart illustrating operating frequency correction processing by a control circuit, such as in FIG. 11A.

### EMBODIMENTS OF THE INVENTION

Hereinafter, a non-contact power feeding device according to one or more embodiments and a control method for the same will be described, with reference to the drawings. As described above, with non-contact power feeding that utilizes resonance between a coil on the power transmission side and a coil on the power reception side, the resonant frequency changes, according to the distance between the coil on the power transmission side (hereinafter called the transmitting coil), and the coil on the power reception side (hereinafter called the receiving coil). In view of this, this non-contact power feeding device starts power feeding with an initial frequency higher than the maximum value of the frequency corresponding to a local minimum value of the frequency characteristics of impedance of a power transmission circuit as the operating frequency, and gradually lowers the operating frequency and raises the AC voltage. This non-contact power feeding device then fixes the operating frequency when the AC voltage reaches a prescribed voltage. This non-contact power feeding device thereby suppresses any decrease in the energy transfer power amount, by enabling AC power having an operating frequency near the resonant frequency and located in the impedance range to be supplied to the transmitting coil, regardless of the distance between the transmitting coil and the receiving coil.

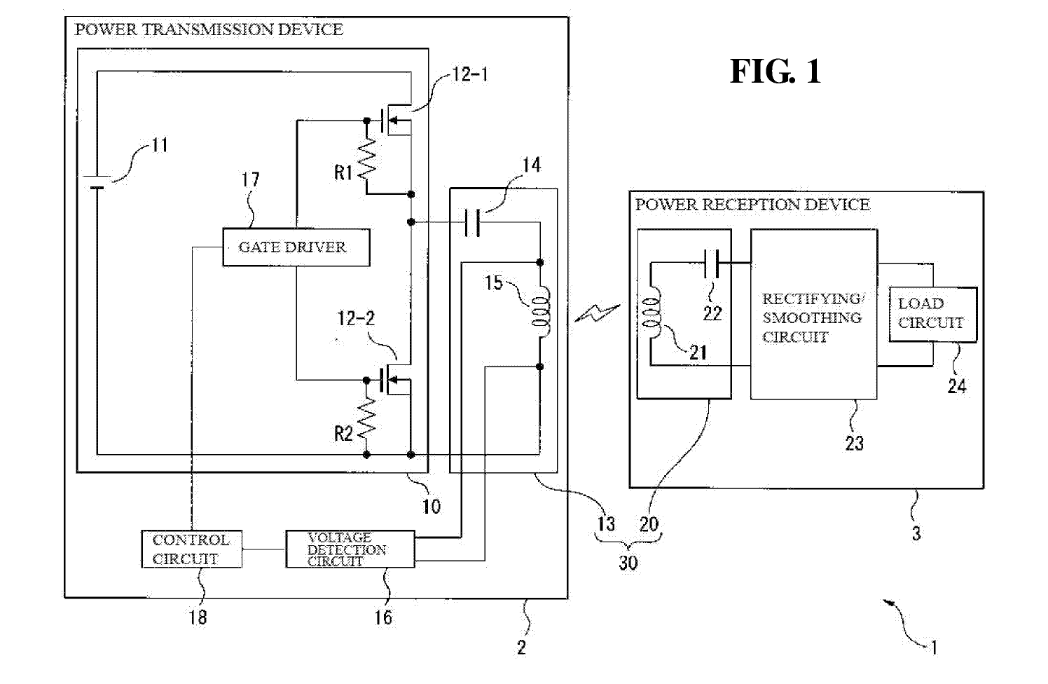

FIG. 1 is a schematic configuration diagram of the non-contact power feeding device according to one or more embodiments. As shown in FIG. 1, a non-contact power feeding device 1 has a power transmission device 2 and a power reception device 3 to which power is transmitted through space from the power transmission device 2. The power transmission device 2 has a power supply circuit 10, a transmitting resonant circuit 13 having a transmitting capacitor 14 and a transmitting coil 15, a voltage detection circuit 16, a gate driver 17, and a control circuit 18. On the other hand, the power reception device 3 has a receiving resonant circuit 20 having a receiving coil 21 and a receiving capacitor 22, a rectifying/smoothing circuit 23, and a load circuit 24.

First, the power transmission device 2 will be described.

The power supply circuit 10 supplies AC power having an adjustable operating frequency to the transmitting resonant circuit 13. For that purpose, the power supply circuit 10 has a direct current (DC) power source 11 and two switching elements 12-1 and 12-2.

The DC power source 11 supplies DC power having a predetermined voltage. For that purpose, the DC power source 11 may, for example, have a battery. Alternatively, the DC power source 11 may be connected to a commercial AC power source, and have a smoothing capacitor and a full-wave rectifying circuit for converting AC power supplied from the AC power source into DC power.

The two switching elements 12-1 and 12-2 are connected in series between the positive electrode side terminal and the negative electrode side terminal of the DC power source 11. Also, in one or more embodiments, the switching element 12-1 is connected to the positive electrode side of the DC power source 11, whereas the switching element 12-2 is connected to the negative electrode side of the DC power source 11. The switching elements 12-1 and 12-2 can, for example, be configured as n-channel MOSFETs. The drain terminal of the switching element 12-1 is connected to the positive electrode side terminal of the DC power source 11, and the source terminal of the switching element 12-1 is connected to the drain terminal of the switching element 12-2. Also, the source terminal of the switching element 12-2 is connected to the negative electrode side terminal of the DC power source 11. Furthermore, the source terminal of the switching element 12-1 and the drain terminal of the switching element 12-2 are connected to one end of the transmitting coil 15 via the transmitting capacitor 14, and the source terminal of the switching element 12-2 is directly connected to the other end of the transmitting coil 15.

Also, the gate terminals of the switching elements 12-1 and 12-2 are connected to the control circuit 18 via the gate driver 17. Furthermore, the gate terminals of the switching elements 12-1 and 12-2 are respectively connected to the source terminal via resistors R1 and R2, in order to ensure that the switching elements will turn on when a voltage for turning on the switching elements is applied. The switching elements 12-1 and 12-2 are switched on and off alternately, by a control signal from the control circuit 18. The DC power supplied from the DC power source 11 is converted into AC power through charging and discharging by the transmitting capacitor 14, and the AC power is supplied to the transmitting resonant circuit 13 composed of the transmitting capacitor 14 and the transmitting coil 15.

The transmitting resonant circuit 13 is an LC resonant circuit that is formed by the transmitting capacitor 14 and the transmitting coil 15. The transmitting capacitor 14 is connected at one end to the source terminal of the switching element 12-1 and the drain terminal of the switching element 12-2, and is connected at the other end to the transmitting coil 15.

One end of the transmitting coil 15 is connected to the other end of the transmitting capacitor 14, and the other end of the transmitting coil 15 is connected to the negative electrode side terminal of the DC power source 11 and the source terminal of the switching element 12-2. The transmitting coil 15 then produces a magnetic field that depends on the current flowing through the transmitting coil 15 itself, using the AC power supplied from the power supply circuit 10. In the case where the distance between the transmitting coil 15 and the receiving coil 21 is short enough to enable resonance to occur, the transmitting coil 15 resonates with the receiving coil 21, and transmits power to the receiving coil 21 through space.

The voltage detection circuit 16 detects the AC voltage applied between both terminals of the transmitting coil 15, every predetermined period. Note that the predetermined period is, for example, set to be longer than a period corresponding to a smallest value envisaged for the operating frequency of the AC power that is supplied to the transmitting coil 15, such as 50 msec to 1 sec, for example. Also, the voltage detection circuit 16 measures the peak value or the effective value of the AC voltage, for example, as the AC voltage that is detected. The voltage detection circuit 16 then outputs a voltage detection signal representing the AC voltage to the control circuit 18. Thus, the voltage detection circuit 16 can be configured as any of various voltage detection circuits that are able to detect an AC voltage, for example.

The gate driver 17 receives a control signal for switching on/off of the switching elements 12-1 and 12-2 from the control circuit 18, and changes the voltage that is applied to the gate terminals of the switching elements 12-1 and 12-2 according to the control signal. That is, the gate driver 17, upon receiving a control signal for turning on the switching element 12-1, applies a relatively high voltage to the gate terminal of the switching element 12-1, such that the switching element 12-1 turns on, and the current from the DC power source 11 flows through the switching element 12-1. On the other hand, the gate driver 17, upon receiving a control signal for turning off the switching element 12-1, applies a relatively low voltage to the gate terminal of the switching element 12-1, such that the switching element 12-1 turns off, and the current from the DC power source 11 no longer flows through the switching element 12-1. The gate driver 17 also similarly controls the voltage that is applied to the gate terminal of the switching element 12-2.

The control circuit 18 has, for example, nonvolatile and volatile memory circuits, a computational circuit and an interface circuit for connecting to other circuits, and the operating frequency of the power supply circuit 10, that is, the operating frequency of the AC power that the power supply circuit 10 supplies to the transmitting resonant circuit 13, is adjusted according to the AC voltage applied to the transmitting coil 15 which is indicated by the voltage detection signal.

Thus, in one or more embodiments, the control circuit 18 controls the switching elements 12-1 and 12-2, such that the switching element 12-1 and the switching element 12-2 turn on alternately, and the time period during which the switching element 12-1 is on and the time period during which the switching element 12-2 is on within one period corresponding to the operating frequency are equal. Note that the control circuit 18 may provide dead time during which both switching elements are off, when switching on/off of the switching element 12-1 and the switching element 12-2, in order to prevent the switching element 12-1 and the switching element 12-2 turning on at the same time, and the DC power source 11 being short-circuited.

In one or more embodiments, the control circuit 18 changes the operating frequency, that is, the on/off switching period of the switching elements 12-1 and 12-2, in a direction in which the AC voltage that is applied to the transmitting coil 15 increases.

Note that control of the switching elements 12-1 and 12-2 by the control circuit 18 will be discussed in detail later.

Next, the power reception device 3 will be described.

The receiving resonant circuit 20 is an LC resonant circuit consisting of the receiving coil 21 and the receiving capacitor 22. The receiving coil 21 that is provided in the receiving resonant circuit 20 is connected at one end to the receiving capacitor 22, and is connected at the other end to the rectifying/smoothing circuit 23.

The receiving coil 21 resonates with the transmitting coil 15 and receives power from the transmitting coil 15, due to resonance occurring with the magnetic field produced by the AC current that flows to the transmitting coil 15 of the power transmission device 2. The receiving coil 21 then outputs received power to the rectifying/smoothing circuit 23 via the receiving capacitor 22. Note that the number of turns of the receiving coil 21 and the number of turns of the transmitting coil 15 of the power transmission device 2 may be the same or may differ. Also, the inductance of the receiving coil 21 and the electrostatic capacity of the receiving capacitor 22 are preferably set, such that the resonant frequency of the receiving resonant circuit 20 and the resonant frequency of the transmitting resonant circuit 13 of the power transmission device 2 will be equal. The receiving resonant circuit 20 forms a power transmission circuit 30 together with the transmitting resonant circuit 13.

The receiving capacitor 22 is connected at one end to the receiving coil 21, and is connected at the other end to the rectifying/smoothing circuit 23. The receiving capacitor 22 then outputs power received by the receiving coil 21 to the rectifying/smoothing circuit 23.

The rectifying/smoothing circuit 23 rectifies and smoothes the power received using the receiving coil 21 and the receiving capacitor 22, and converts the received power into DC power. The rectifying/smoothing circuit 23 then outputs the DC power to the load circuit 24. For that purpose, the rectifying/smoothing circuit 23 has, for example, a full-wave rectifying circuit and a smoothing capacitor.

Hereinafter, operations of the non-contact power feeding device 1 will be described in detail.

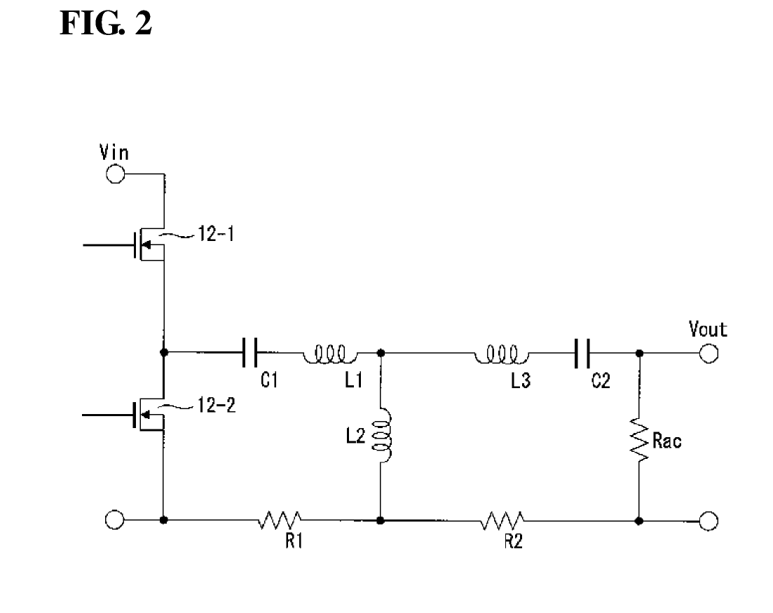

FIG. 2 is an equivalent circuit diagram of the power transmission circuit 30 including the transmitting resonant circuit 13 and the receiving resonant circuit 20. Here, L₁ and L₃ are respectively the leakage inductances on the power transmission side and the power reception side, and L₂ is the mutual inductance. L₁=L₃=(1−k)L₀ and L₂=kL₀, where L₀ is the self-inductance of the transmitting coil 15 and the receiving coil 21, and k is the degree of coupling between the transmitting coil 15 and the receiving coil 21. For example, L₁=L₃=8.205 μH and L₂=22.3 μH when L₀=30.5 μH and k=0.731028. Generally, the degree of coupling k increases as the distance between the transmitting coil 15 and the receiving coil 21 narrows. In this case, a transmission matrix A(f), which is represented by F parameter analysis, is represented with the following equation.

$$\begin{matrix}Equation 1 & \\ A ( {f}_{s} ) = [ \begin{matrix}1 & \frac{1}{s ( {f}_{s} ) \cdot C 1} \\ 0 & 1\end{matrix} ] \cdot [ \begin{matrix}1 & s ( {f}_{s} ) \cdot L 1 + R 2 \\ 0 & 1\end{matrix} ] \cdot [ \begin{matrix}1 & 0 \\ \frac{1}{s ( {f}_{s} ) \cdot L 2} & 1\end{matrix} ] \cdot [ \begin{matrix}1 & s ( {f}_{s} ) \cdot L 3 + R 3 \\ 0 & 1\end{matrix} ] \cdot [ \begin{matrix}1 & \frac{1}{s ( {f}_{s} ) \cdot C 3} \\ 0 & 1\end{matrix} ] \cdot [ \begin{matrix}1 & 0 \\ \frac{1}{Rac} & 1\end{matrix} ] & ( 1 )\end{matrix}$$

Here, fₛ is the operating frequency of the power supply circuit 10, s(f)=jω and ω=2nf. C1 and C2 are respectively the electrostatic capacities on the power transmission side and the power reception side. R1 and R2 are the impedances on the power transmission side and the power reception side. Rac is the impedance of the load circuit.

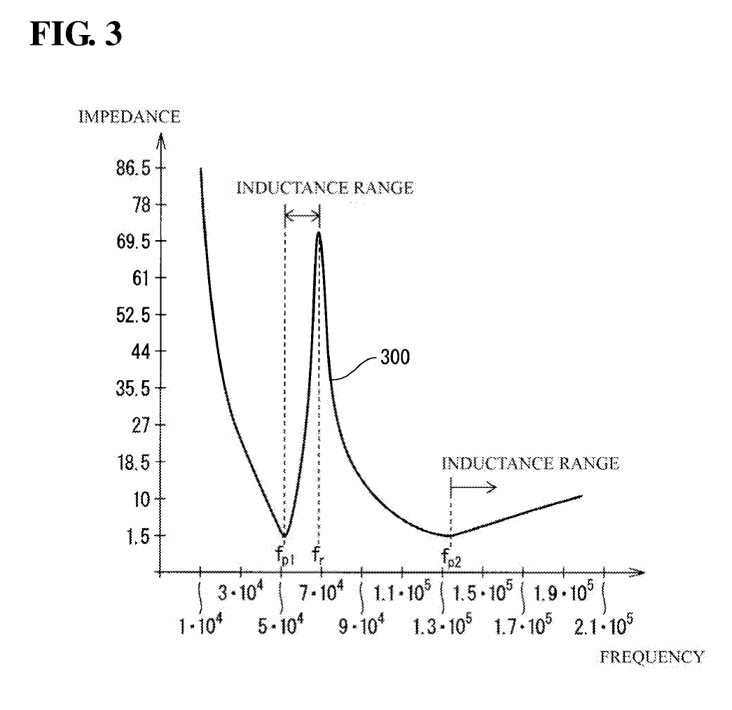

FIG. 3 is a diagram showing an example of the frequency characteristics of impedance of the equivalent circuit shown in FIG. 2. In FIG. 3, the horizontal axis represents frequency and the vertical axis represents impedance. Note that the impedance of the equivalent circuit is calculated as the absolute value of the ratio of the element on the upper left to the element on the lower left in the transmission matrix A(f) of equation (1), which is represented with two rows and two columns. A graph 300 represents the frequency characteristics of impedance. Note that the graph 300 was calculated based on equation (1), where L₀=30.5 μH and k=0.731028, and where C1=C2=180 nF and R1=R2=270 mΩ.

As shown in FIG. 3, in the case where the degree of coupling k is comparatively large, the frequency characteristics of impedance has two local minimum values at a first resonant frequency fₚ₁ that is smaller than the resonant frequency fₛ of the transmitting resonant circuit 13 and a second resonant frequency fₚ₂ that is larger than the resonant frequency fₛ. That is, the transmitting coil 15 and the receiving coil 21 resonate at two frequencies, and at each resonant frequency, the impedance is at a local minimum, that is, the energy transfer power amount is at a local maximum. The resonance frequency fₛ of the transmitting resonant circuit 13 is given by the following equation.

$$\begin{matrix}Equation 2 & \\ {f}_{r} = \frac{1}{2 π \sqrt{LC}} & ( 2 )\end{matrix}$$

Here, L is the inductance of the transmitting coil 15, and C is the capacitance of the transmitting capacitor 14. Also, the first resonant frequency fₚ₁ and the second resonant frequency fₚ₂ are given by the following equations.

$$\begin{matrix}Equation 3 & \\ {f}_{p 1} = \frac{{f}_{r}}{\sqrt{1 + k}} & ( 3 ) \\ Equation 4 & \\ {f}_{p 2} = \frac{{f}_{r}}{\sqrt{1 - k}} & ( 4 )\end{matrix}$$

Here, k is the degree of coupling between the transmitting coil 15 and the receiving coil 21.

The impedance between the power transmission side and the power reception side decreases, as the operating frequency fₛ of AC power that is supplied to the transmitting resonant circuit 13 of the power transmission device 2 approaches the first resonant frequency fₚ₁ or the second resonant frequency fₚ₂. When the operating frequency fₛ of the AC power approaches the first resonant frequency fₚ₁ or the second resonant frequency fₚ₂, and the impedance between the power transmission side and the power reception side decreases, the energy transfer power amount that is transmitted from the transmitting coil 15 to the receiving coil 21 increases. Thus, the AC voltage between both terminals of the receiving coil 21 on the power reception side also increases, as the operating frequency of AC power that is supplied to the transmitting resonant circuit 13 approaches one of the resonant frequencies.

In FIG. 3, a frequency domain higher than the first resonant frequency fₚ₁ and lower than the resonant frequency fₛ of the transmitting resonant circuit 13 and a frequency domain higher than the second resonant frequency fₚ₂ are inductance ranges. The non-contact power feeding device 1 operates at the operating frequency fₛ that is included in the inductance ranges, which are the frequency domain higher than the first resonant frequency fₚ₁ and lower than the resonant frequency fₛ of the transmitting resonant circuit 13 and the frequency domain higher than the second resonant frequency fₚ₂. A reactance area is an area in which the AC current lags the AC voltage, and thus the AC current will take a negative value when the phase of the AC voltage is 0 degrees and the switching elements 12-1 and 12-2 switch. As a result of the AC current taking a negative value when the switching elements 12-1 and 12-2 switch, soft switching becomes possible in the non-contact power feeding device 1.

Also, the relationship between the AC voltage on the power reception side and the AC voltage on the power transmission side is represented with the following relational equation.

$$\begin{matrix}Equation 5 & \\ {V}_{2} = \frac{{n}_{2}}{{n}_{1}} {kV}_{1} & ( 5 )\end{matrix}$$

Here, V1 is the AC voltage on the power transmission side, that is, the AC voltage that is applied to the transmitting coil 15, V2 is the AC voltage on the power reception side, that is, the AC voltage that is applied to the receiving coil 21. k is the degree of coupling. n1 and n2 are respectively the number of turns of the transmitting coil 15 and the number of turns of the receiving coil 21. As shown in equation (5), a stronger correlation relationship occurs between the voltage on the power reception side and the voltage on the power transmission side, as the degree of coupling increases. Thus, as long as the distance between the transmitting coil 15 and the receiving coil 21 is short and there is a certain degree of coupling, the AC voltage that is applied to the transmitting coil 15 on the power transmission side also increases, as the AC voltage of the receiving coil 21 on the power reception side increases, that is, as the power that can be extracted on the power reception side increases.

The control circuit 18 of the power transmission device 2 changes the operating frequency fₛ of AC power supplied to the transmitting resonant circuit 13, such that the AC voltage applied to the transmitting coil 15, which is indicated by the voltage detection signal, increases and the non-contact power feeding device operates in the impedance range. That is, the control circuit 18 of the power transmission device 2 sets the on/off switching period of the switching elements 12-1 and 12-2, such that the AC voltage that is applied to the transmitting coil 15 is high and the non-contact power feeding device operates in the inductance range.

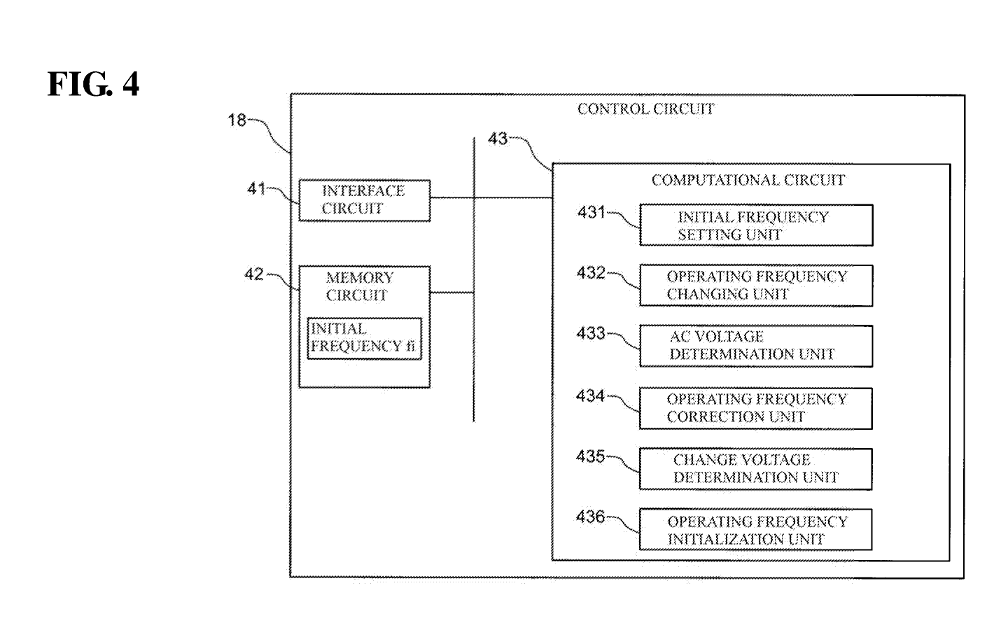

FIG. 4 is an internal block diagram of the control circuit 18.

The control circuit 18 has an interface circuit 41, a memory circuit 42, and a computational circuit 43.

The interface circuit 41 outputs, to the computational circuit 43, an AC voltage signal indicating the AC voltage to be applied to the transmitting coil 15 which is indicated by the voltage detection signal input from the voltage detection circuit 16. Also, the interface circuit 41 outputs, to the switching elements 12-1 and 12-2, a control signal including the operating frequency fₛ that is input from the computational circuit 43. The memory circuit 42 has a ROM and a RAM, and stores an initial frequency fᵢ. The initial frequency fᵢ is a higher frequency than the maximum value of the second resonant frequency fₚ₂ of the frequency characteristics of impedance of the power transmission circuit 30.

In one example, the initial frequency fᵢ may be twice the frequency of the resonant frequency fₛ of the transmitting resonant circuit 13. With the non-contact power feeding device, the degree of coupling k is often less than 0.75, and the initial frequency fᵢ can be positioned in the inductance range, by setting the initial frequency fᵢ to twice the frequency of the resonant frequency fₛ of the transmitting resonant circuit 13 based on equation (2).

The computational circuit 43 has an initial frequency setting unit 431, an operating frequency changing unit 432, an AC voltage determination unit 433, an operating frequency correction unit 434, a change voltage determination unit 435 and an operating frequency initialization unit 436. These units provided in the computational circuit 43 are functional modules that are implemented by a program executed on a processor provided in the computational circuit 43. Alternatively, these units provided in the computational circuit 43 may be implemented in the power transmission device 2 as an independent integrated circuit, microprocessor or firmware.

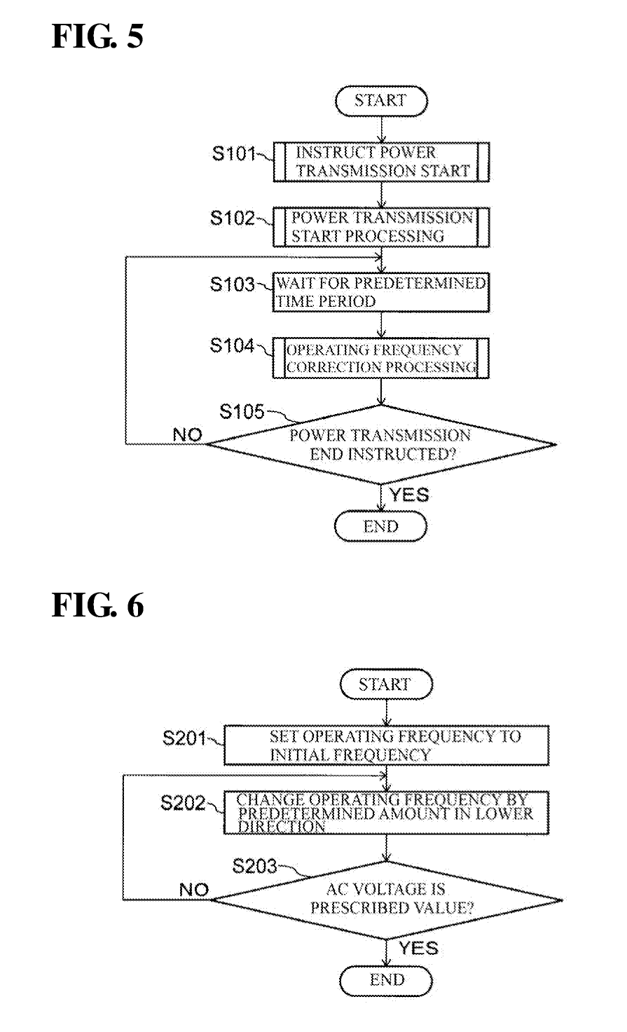

FIG. 5 is a flowchart of power transmission processing by the computational circuit 43.

First, the computational circuit 43, when a power transmission start instruction signal indicating to instruct the start of power transmission is input from a higher-level device which is not shown (S101), executes power transmission start processing (S102). The computational circuit 43, after waiting for a predetermined time period (S103), executes operating frequency correction processing (S104). The computational circuit 43 repeats the processing of S103 to S105 until a power transmission end instruction signal indicating to instruct the end of power transmission is input from the higher-level device which is not shown (S105). When the power transmission end instruction signal is input from the higher-level device which is not shown (S105), the computational circuit 43 ends the power transmission processing.

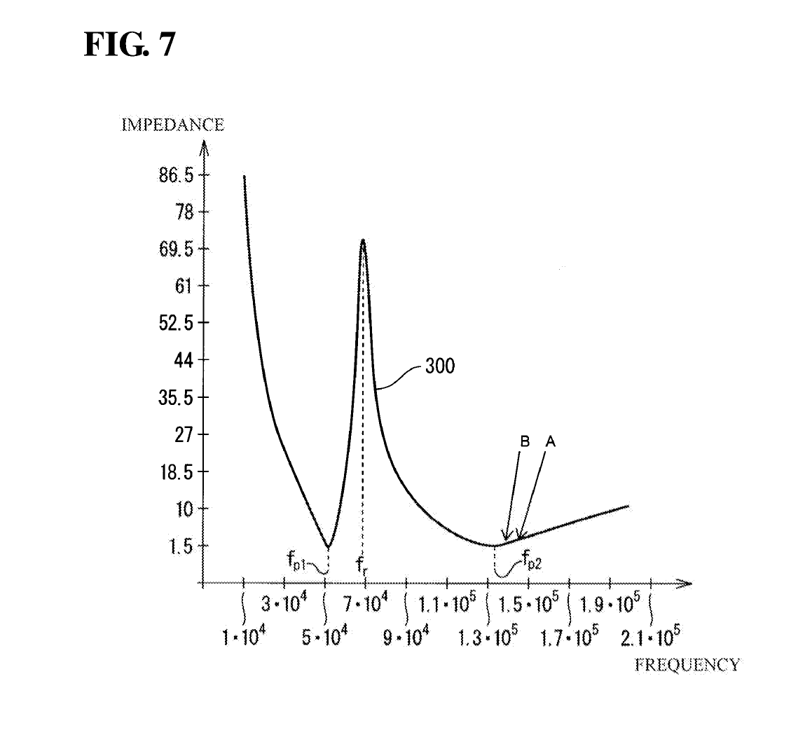

FIG. 6 is a detailed flowchart of the power transmission start processing (S102).

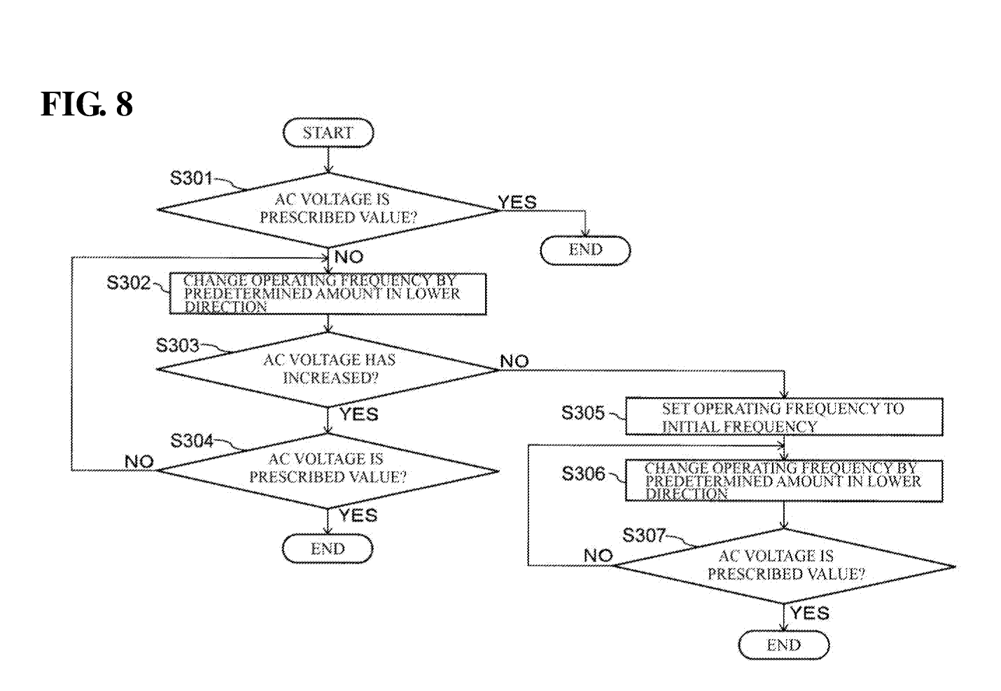

First, the initial frequency setting unit 431 outputs a control signal indicating to set the operating frequency fₛ to the initial frequency fᵢ that is stored in the memory circuit 42 to the switching elements 12-1 and 12-2 (S201). The initial frequency fᵢ is shown with an arrow A in FIG. 7. Next, the operating frequency changing unit 432 outputs a control signal indicating to change the operating frequency fₛ by a predetermined amount in a lower direction to the switching elements 12-1 and 12-2 (S202). Next, the AC voltage determination unit 433 determines whether the AC voltage that is applied to the transmitting coil 15, which is indicated by the voltage detection signal input from the voltage detection circuit 16, has reached a prescribed value (S203). The impedance corresponding to the prescribed value is shown with an arrow B in FIG. 7. When the AC voltage determination unit 433 determines that the AC voltage that is applied to the transmitting coil 15 has not reached the prescribed value, the processing returns to S201. Thereafter, the processing of S201 to S203 is repeated, until the AC voltage determination unit 433 determines that the AC voltage that is applied to the transmitting coil 15 has reached the prescribed value. When the AC voltage determination unit 433 determines that the AC voltage that is applied to the transmitting coil 15 has reached the prescribed value (S203), the processing ends.

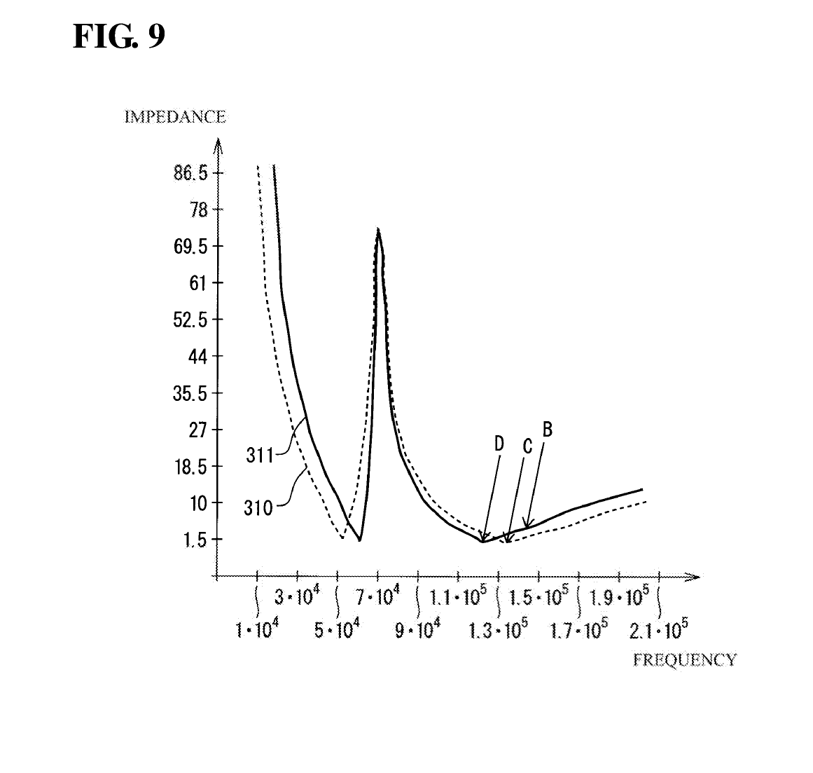

FIG. 8 is a detailed flowchart of the operating frequency correction processing (S104).

First, the AC voltage determination unit 433 determines whether the AC voltage that is applied to the transmitting coil 15, which is indicated by the voltage detection signal input from the voltage detection circuit 16, is a prescribed value (S301). Since the degree of coupling k does not change from when the power transmission start processing is executed due to the distance between the transmitting coil 15 and the receiving coil 21 not changing, in the case where it is judged that the AC voltage is the prescribed value (S301), the processing ends.

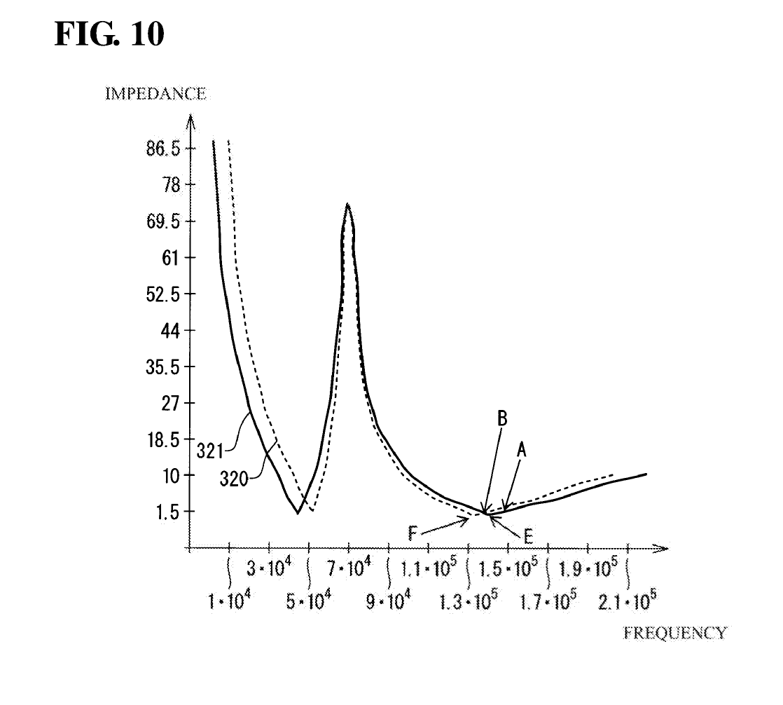

When it is determined that the AC voltage differs from the prescribed value (S301), the operating frequency correction unit 434 outputs a control signal indicating to change the operating frequency fₛ by a predetermined amount in a lower direction to the switching elements 12-1 and 12-2 (S302). Next, the change voltage determination unit 435 determines whether the AC voltage that is applied to the transmitting coil 15, which is indicated by the voltage detection signal input from the voltage detection circuit 16, has increased (S303). The degree of coupling k decreases when the distance between the transmitting coil 15 and the receiving coil 21 widens. When the degree of coupling k decreases and the frequency characteristics of impedance change as shown from graph 310 to graph 311 as shown in FIG. 9, the second resonant frequency fₚ₂ moves from a frequency shown with an arrow C to a frequency shown with an arrow D. Since the impedance of the frequency at which it is determined that the AC voltage has reached the prescribed value in the power transmission start processing increases, as a result of the second resonant frequency fₚ₂ moving from the position shown with the arrow C to the frequency shown with the arrow D which is a lower frequency than the frequency shown with the arrow C, the AC voltage becomes lower than the prescribed value. As shown with the arrow B in FIG. 9, the AC voltage can increase when the operating frequency fₛ is lowered, because the AC voltage at which it is determined that the AC voltage has reached the prescribed value in the power transmission start processing is lower than the prescribed value. Thereafter, the processing of S302 to S304 is repeated, until the AC voltage determination unit 433 determines that the AC voltage that is applied to the transmitting coil 15 has reached the prescribed value. When the AC voltage determination unit 433 determines that the AC voltage that is applied to the transmitting coil 15 has reached the prescribed value (S304), the processing ends.

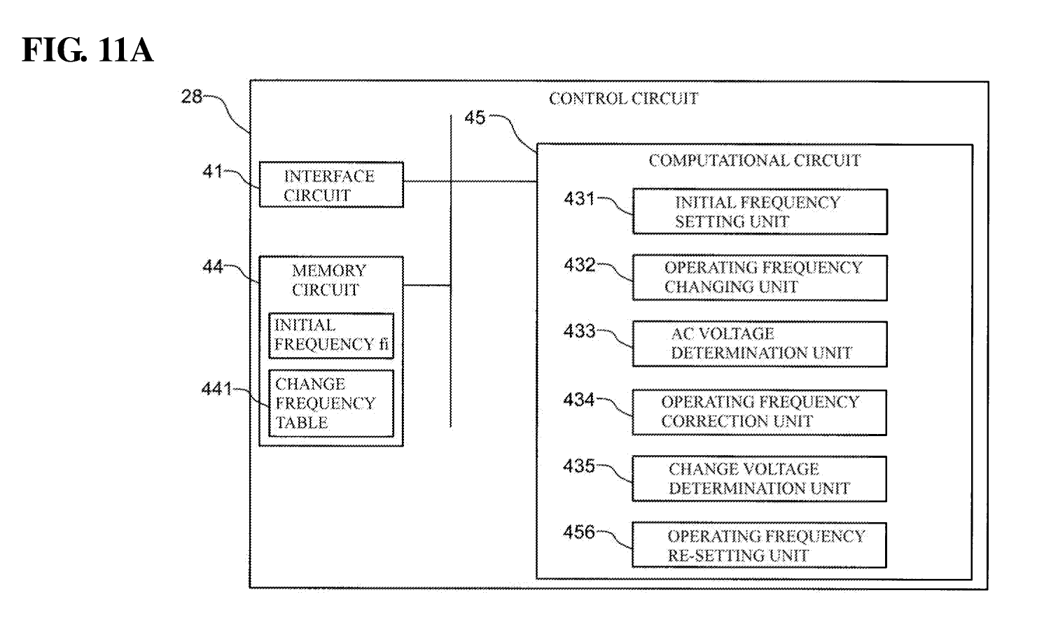

The distance between the transmitting coil 15 and the receiving coil 21 narrows, and the degree of coupling k increases. When the degree of coupling k increases and the frequency characteristics of impedance change as shown from graph 320 to graph 321 as shown in FIG. 10, the second resonant frequency fₚ₂ moves from a frequency shown with an arrow E to a frequency shown with an arrow F. As a result of the second resonant frequency fₚ₂ moving from the position shown with the arrow E to the frequency shown with the arrow F, which is a higher frequency than the frequency shown with the arrow E, the frequency at which it is determined that the AC voltage has reached the prescribed value in the power transmission start processing which is shown with the arrow B in FIG. 10 becomes lower than the second resonant frequency fₚ₂. That is, the frequency at which it is determined that the AC voltage has reached the prescribed value in the power transmission start processing moves from an inductance range to a capacitance range. Because the frequency at which it is determined that the AC voltage has reached the prescribed value in the power transmission start processing moves from an inductance range to a capacitance range, the AC voltage decreases when the operating frequency correction unit 434 changes the operating frequency fₛ by a predetermined amount in a lower direction (S302). In S303, the change voltage determination unit 435 determines that the AC voltage that is applied to the transmitting coil 15, which is indicated by the voltage detection signal input from the voltage detection circuit 16, has decreased (S303). Next, the operating frequency initialization unit 436 outputs a control signal indicating to return the operating frequency fₛ to the initial frequency fᵢ shown with the arrow A in FIG. 10 to the switching elements 12-1 and 12-2 (S305). The processing of S306 to S307 is repeated, until the AC voltage determination unit 433 determines that the AC voltage that is applied to the transmitting coil 15 has reached the prescribed value, similarly to the processing of S102 to S103 shown in FIG. 6. When the AC voltage determination unit 433 determines that the AC voltage that is applied to the transmitting coil 15 has reached the prescribed value (S203), the processing ends.

As has been described above, this non-contact power feeding device monitors the AC voltage that is applied to the transmitting coil, in the power transmission device that transmits power in a non-contact manner to the power reception device, and adjusts the operating frequency of the AC power that is supplied to the resonant circuit including the transmitting coil in a direction in which that AC voltage increases. This non-contact power feeding device is thereby able to approximate the operating frequency to the resonant frequency between the transmitting coil and the receiving coil, regardless of the distance between the two coils, thus enabling any decrease in the energy transfer power amount to be suppressed. Also, this non-contact power feeding device does not need to investigate the distance between the power transmission device and the power reception device or the positional relationship thereof, and can thus be simplified, enabling miniaturization and reduction in manufacturing costs as a result.

Also, this non-contact power feeding device, when starting power transmission, gradually lowers the operating frequency and raises the AC voltage, by setting the operating frequency to the initial frequency which is a higher frequency than the maximum value of the second resonant frequency of the frequency characteristics of impedance of the power transmission circuit. Because of setting the operating frequency to the initial frequency which is a higher frequency than the maximum value of the second resonant frequency of the frequency characteristics of impedance of the power transmission circuit, when starting power transmission, this non-contact power feeding device operates in an inductance range in which soft switching is possible. Because this non-contact power feeding device operates in an inductance range in which soft switching is possible, switching loss can be reduced. Also, this non-contact power feeding device is able to maintain the AC voltage at a desired value, even when the degree of coupling between the transmitting coil and the receiving coil changes in response to a change in the distance between the transmitting coil and the receiving coil, by further changing the operating frequency to be lower, when a predetermined time period has lapsed after power transmission was started. Furthermore, because the operating frequency is returned to the initial frequency, when the operating frequency changes from the inductance range to the capacitance range, this non-contact power feeding device is able to realize soft switching operation in the inductance range.

Note that, according to a variation, the voltage detection circuit 16 may detect the AC voltage that is applied between both terminals of the transmitting capacitor 14. Because the transmitting capacitor 14 and the transmitting coil 15 form an LC resonant circuit, the phase of the AC voltage that is applied to the transmitting capacitor 14 and the phase of the AC voltage that is applied to the transmitting coil 15 are shifted by 90 degrees from each other, and thus the AC voltage that is applied to the transmitting capacitor 14 also increases, as the AC voltage that is applied to the transmitting coil 15 increases. Also, the peak value of the AC voltage that is applied to the transmitting coil 15 is equal to the peak value of the AC voltage that is applied to the transmitting capacitor 14. Accordingly, the voltage detection circuit 16 is able to indirectly detect the AC voltage that is applied to the transmitting coil 15, by detecting the AC voltage that is applied to the transmitting capacitor 14.

Note that, in this case, in order to facilitate detection of the AC voltage that is applied to the transmitting capacitor 14, the transmitting capacitor 14 may be connected between one end of the transmitting coil 15 and both the source terminal of the switching element 12-2 and the negative electrode side terminal of the DC power source 11. The other end of the transmitting coil 15 may then be directly connected to the source terminal of the switching element 12-1 and the drain terminal of the switching element 12-2.

Also, with the non-contact power feeding device 1, the initial frequency setting unit 431 returns the operating frequency fₛ to the initial frequency fᵢ when the AC voltage determination unit 433 determines in the operating frequency correction processing that the AC voltage has decreased. However, with the non-contact power feeding device according to one or more embodiments, the operating frequency fₛ may be moved to a frequency of the inductance range, when it is determined that the AC voltage has decreased.

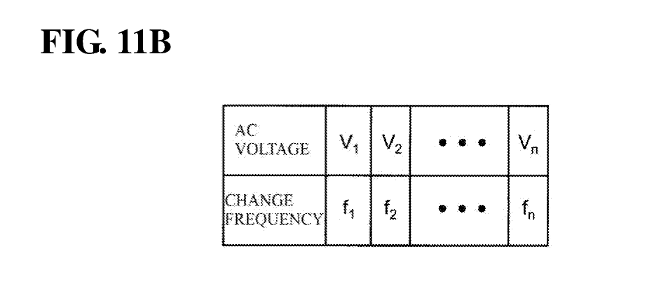

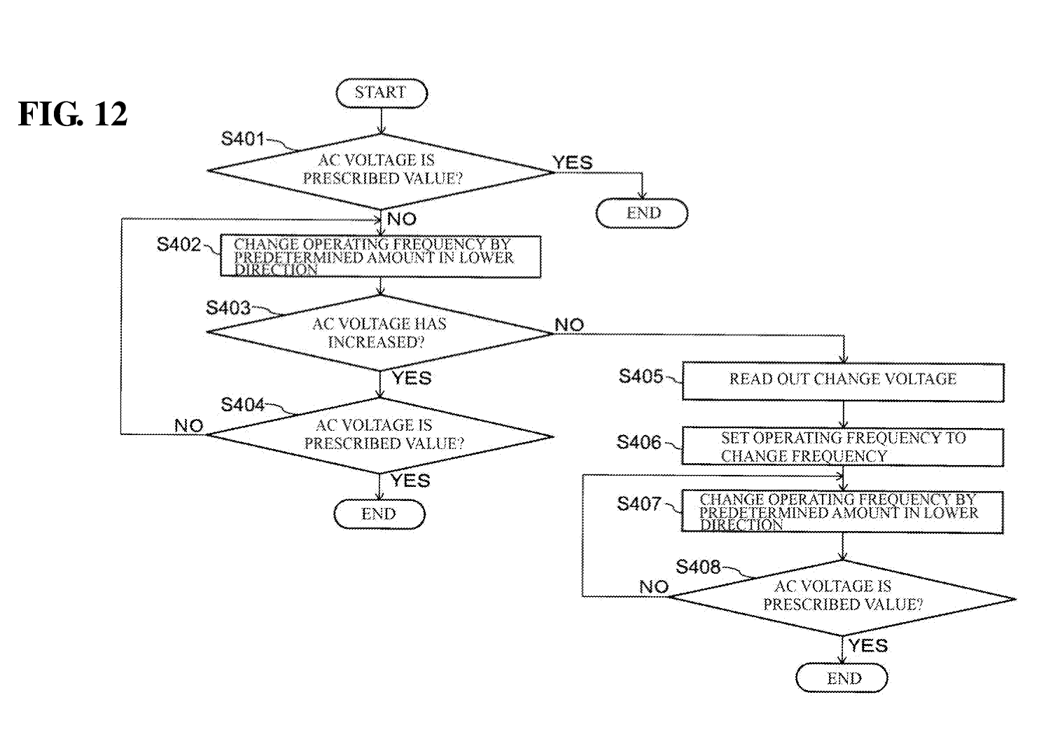

FIG. 11A is an internal block diagram of the control circuit according to another embodiment, FIG. 11B is a diagram showing a change frequency table shown in FIG. 11A, and FIG. 12 is a flowchart of operating frequency correction processing by the control circuit shown in FIG. 11A.

The control circuit 28 differs from the control circuit 18 in that a memory circuit 44 having a change frequency table 441 is disposed in place of the memory circuit 42. Also, the control circuit 28 differs from the control circuit 18 in that a computational circuit 45 having an operating frequency re-setting unit 456 instead of the operating frequency initialization unit 436 is disposed in place of the computational circuit 43. Because the configurations and functions of the constituent elements of the control circuit 28 apart from the change frequency table 441 and the operating frequency re-setting unit 456 have the same configurations and functions as constituent elements of the control circuit 18 that are given the same reference signs, detailed description thereof will be omitted here. Also, because the processing of S401 to S404 and S407 and S408 shown in FIG. 12 is the same processing as the processing of S301 to S304 and S306 and S307 shown in FIG. 8, detailed description thereof will be omitted here.

The change frequency table 441 shows the relationship between the AC voltage at which it is determined that the AC voltage has decreased (S403) and the change frequency which is located in an inductance range and is smaller than the initial frequency fᵢ. In one example, the change frequency may be a frequency of the inductance range in proximity to the frequency corresponding to a prescribed value. Because the frequency characteristics of impedance are uniquely determined according to the degree of coupling k between the transmitting coil 15 and the receiving coil 21, as shown in equation (1) , the change frequency is uniquely determined according to the AC voltage at which it is determined that the AC voltage has decreased. The operating frequency re-setting unit 456 moves the operating frequency fₛ to the change frequency corresponding to the AC voltage at which it is determined that the AC voltage has decreased, with reference to the change frequency table 441 (S403). When it is determined that the AC voltage has decreased (S403), the operating frequency re-setting unit 456 sets the operating frequency fₛ to the change frequency corresponding to the AC voltage at which it is determined that the AC voltage has decreased with reference to the change frequency table 441 (S405).

Furthermore, in the power transmission device 2, the power supply circuit that supplies AC power to the transmitting resonant circuit 13 may have a different circuit configuration from the above, as long as the circuit is able to variably adjust the operating frequency.

In this way, a person skilled in the art is able to make various changes in accordance with the mode that is carried out, within the scope of the invention.

1. A non-contact power feeding device comprising a power transmission device and a power reception device having a receiving resonant circuit including a receiving coil to which power is transmitted in a non-contact manner from the power transmission device,
the power transmission device including:
a transmitting resonant circuit having a capacitor and a transmitting coil connected to one end of the capacitor and configured to perform power transmission with the receiving coil;
a power supply circuit configured to supply AC power having an adjustable operating frequency to the power transmission resonant circuit;
a voltage detection circuit configured to detect an AC voltage applied to the transmitting coil; and
a control circuit configured to adjust the operating frequency of the AC power supplied from the power supply circuit,
wherein the control circuit has:
a storage unit configured to store an initial frequency higher than any of resonant frequencies at which an impedance of a power transmission circuit including the transmitting resonant circuit and the receiving resonant circuit takes a local minimum value;
an initial frequency setting unit configured to set the operating frequency to the initial frequency when starting non-contact power feeding to the power reception device;
an operating frequency changing unit configured to change the operating frequency in a lower direction; and
an AC voltage determination unit configured to determine whether the AC voltage has reached a prescribed value, and
the operating frequency changing unit ends processing for changing the operating frequency, when it is determined that the AC voltage has reached the prescribed value.

2. The non-contact power feeding device according to claim 1,
wherein the control circuit further includes:
an operating frequency correction unit configured to further change the operating frequency to be lower, when a predetermined time period has elapsed after it is determined that the AC voltage has reached the prescribed value;
a change voltage determination unit configured to determine whether the AC voltage after the change is higher than the AC voltage before the change; and
an operating frequency re-setting unit configured to move the operating frequency to a change frequency that is higher than any of the resonant frequencies and less than or equal to the initial frequency, when it is determined that the AC voltage after the change is higher than the AC voltage before the change.

3. The non-contact power feeding device according to claim 2,
wherein the change frequency is the initial frequency.

4. The non-contact power feeding device according to claim 2,
wherein the storage unit further stores a change frequency table showing a relationship between the AC voltage and the change frequency, and
the operating frequency re-setting unit changes the operating frequency to the change frequency, with reference to the change frequency table.

5. A control method for a non-contact power feeding device including a power transmission device and a power reception device, the power transmission device having a transmitting resonant circuit having a capacitor and a transmitting coil connected to one end of the capacitor, a power supply circuit configured to supply AC power having an adjustable operating frequency to the transmitting resonant circuit, a voltage detection circuit configured to detect an AC voltage applied to the transmitting coil, and a control circuit configured to adjust the operating frequency of the AC power supplied from the power supply circuit, and the power reception device having a receiving resonant circuit including a receiving coil to which power is transmitted in a non-contact manner from the power transmission device, the control method comprising:
setting an initial frequency higher than any of two resonant frequencies at which an impedance of a power transmission circuit including the transmitting resonant circuit and the receiving resonant circuit takes a local minimum value as the operating frequency, when starting non-contact power feeding to the power reception device;
changing the operating frequency in a lower direction;
determining whether the AC voltage has reached a prescribed value; and
ending processing for changing the operating frequency, when it is determined that the AC voltage has reached the prescribed value.
